(19) United States
(12) Patent Application Publication
(10) Pub. No.: US 2026/0250869 A1
(43) Pub. Date: Aug. 27, 2026

(54) ELECTROLYSIS CIRCUIT AND SYSTEM STARTUP MODE

(71) Applicant: Siemens Energy Global GmbH & Co. KG, München (DE)

(72) Inventors: Sven Schumann, Wilhermsdorf (DE); Nemanja Calic, Erlangen (DE)

(21) Appl. No.: 19/160,071

(22) PCT Filed: Jun. 7, 2023
(86) PCT No.: PCT/US2023/024670

§ 371 Date: Aug. 27, 2025

(51) Int. Cl. C25B 15/02; H02M 1/12; H02M 1/14; H02M 1/36; H02M 7/217

(52) U.S. Cl. CPC C25B 15/02; H02M 1/12; H02M 1/14; H02M 1/36; H02M 7/217

(57) ABSTRACT

An electrolysis electrical circuit 14 operatively connected to an AC power source 16 and an electrolysis system 10 is provided, the circuit 14 having: an IGBT rectifier 20 configured to convert the AC power source 16 current to DC and to accommodate fast switching; a DC bus capacitor 30 configured to control the voltage of the downstream DC bus and to power the electrolysis system 10; and a polarization rectifier 40 configured to pre-charge the DC bus capacitor 30 prior to startup of the electrolysis system 10, whereby an inrush current from the AC power source 16 to the DC bus capacitor 30 is reduced.

### BACKGROUND

### 1. Field

The present invention relates in general to an electrolysis circuit and system startup mode, and more specifically to an electrolysis circuit used with an electrolysis system comprising an IGBT rectifier (or any other converter system featuring a DC bus capacitor) and a polarization rectifier wherein the polarization rectifier pre-charges a DC bus capacitor powering the electrolysis system and reduces inrush current at startup.

### 2. Description of the Related Art

Electrolysis, using electricity to react water into hydrogen and oxygen, has many uses. One use of electrolysis and electrolysis systems and cells is as a clean energy input, where the produced hydrogen is used as a clean fuel for hydrogen-powered turbines.

However, when an electrolysis system is operatively connected to or with an electrical circuit that utilizes an IBGT rectifier (the use of an IGBT rectifier having its own various advantages and disadvantages), the IGBT rectifier topology with its DC bus capacitor causes a high inrush current when the DC bus capacitor is “switched on” or powered. This is because the high inrush current increases the required short circuit power of the power source and the current rating of components used. There are several ways to address this high inrush current problem, for example by utilizing robust circuitry components to better withstand high inrush current, for another example by utilizing a charging resistor in parallel to the power source and switching onto the resistor during startup to reduce the inrush current (see prior art FIGS. 1A and 1B). However, there remains a need to better resolve this high inrush current problem for electrolysis systems and circuits, particularly when an IBGT rectifier is used, as well as a need for an improved electrolysis system and circuit start-up mode.

### SUMMARY

In an aspect of the invention, an electrolysis electrical circuit 14 operatively connected to an electrolysis system 10 is provided, comprising: (i) an IGBT rectifier 20 arranged downstream of an AC power source 16, the IGBT rectifier 20 configured to convert the AC power source 16 current to DC; (ii) a DC bus capacitor 30 arranged downstream of the IGBT rectifier 20, the DC bus capacitor 30 configured to control the voltage of the downstream DC bus and to enable powering of the electrolysis system 10; and (iii) a polarization rectifier 40 arranged downstream of the DC bus capacitor 30 and in parallel to the IGBT rectifier 20, the polarization rectifier 40 configured to pre-charge the DC bus capacitor 30 prior to startup of the electrolysis system 10; whereby an inrush current from the AC power source 16 to the DC bus capacitor 30 is reduced. In another aspect, the polarization rectifier 40 is used to prevent the electrolysis system 10 from operating in a reverse fuel-cell mode after power off by maintaining the electrolysis voltage close to the transition voltage when the electrolysis cells 12 switch from fuel-cell mode to electrolysis mode.

In another aspect of the invention, an electrolysis system 10 startup mode is provided, comprising: (i) pre-charging a DC bus capacitor 30 prior to startup of the electrolysis system 10 via a polarization rectifier 40 arranged downstream of the DC bus capacitor 30; (ii) receiving AC power from an AC power source 16 in order to startup the electrolysis system 10; (iii) reducing a startup inrush current from the AC power source 16 to the DC bus capacitor 30 by pre-charging the DC bus capacitor 30; (iv) converting the AC power to DC power via an IGBT rectifier 20 arranged downstream of the AC power source 16 and configured to accommodate fast switching; and (v) enabling powering of the electrolysis system 10 via the DC bus capacitor 30.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1A is a diagram of a prior art electrolysis circuit having an IGBT rectifier (or any other converter system featuring a DC bus capacitor) and switchgear comprising a charging resistor arranged upstream, wherein the charging resistor is switched on during startup to limit the inrush current from the power source which mainly charges the DC bus capacitor.

FIG. 1B is a diagram of the prior art electrolysis circuit of FIG. 1A, wherein the charging resistor is switched off after dissipation of the high inrush current at startup to reduce the operational losses.

FIG. 2A is a diagram of an electrolysis circuit having an IGBT rectifier (or any other converter system featuring a DC bus capacitor) and a polarization rectifier, wherein the polarization rectifier pre-charges the DC bus capacitor prior to startup, in accordance with an exemplary embodiment of the subject matter.

FIG. 2B is a diagram of the electrolysis circuit of FIG. 2A, wherein the DC bus capacitor has been pre-charged by the polarization rectifier prior to arrival of the startup high inrush current from the power source, in accordance with an exemplary embodiment of the subject matter.

FIG. 3 is a voltage versus time diagram showing the DC bus capacitor voltage and current at startup.

### DETAILED DESCRIPTION

In the following detailed description of the present invention, reference is made to the accompanying drawings that form a part hereof, and in which is shown by way of illustration, and not by way of limitation, specific embodiments by which the invention may be practiced. It is to be understood that other embodiments may be utilized and that changes may be made without departing from the spirit and scope of the subject matter or present invention.

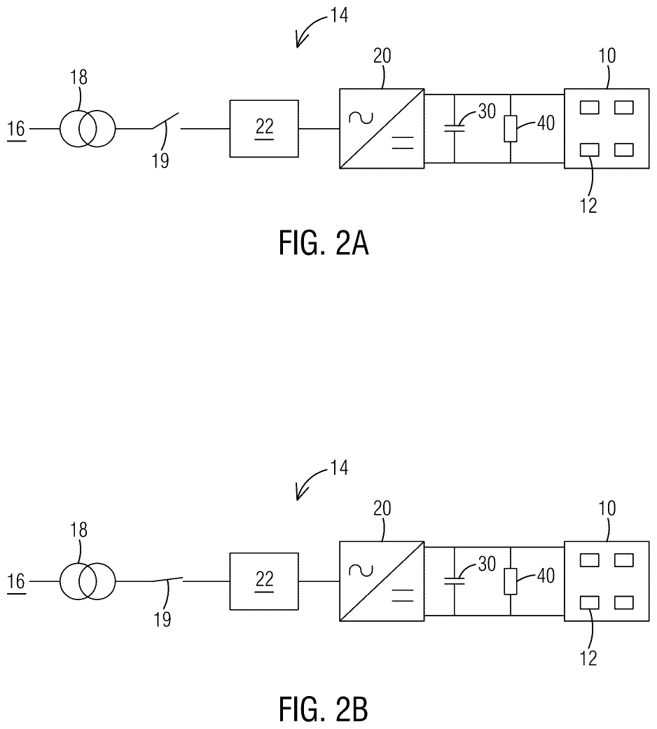

As illustrated in FIGS. 2A and 2B, an electrolysis system 10 operatively connected to an upstream AC power source 16 and an electrolysis electrical circuit 14 that is utilized at startup of the electrolysis system 10 is provided. The illustrated circuit 14 comprises: (i) an IGBT rectifier 20 (or any other converter system featuring a DC bus capacitor) configured to convert the AC power source 16 current to DC and to accommodate fast switching onto or off the AC power source 16, (ii) a DC bus capacitor 30 configured to smooth and control the voltage of the downstream DC bus, and (iii) a polarization rectifier 40 configured to pre-charge the DC bus capacitor 30 prior to startup of the electrolysis system 10. By this configuration, inrush current from the AC power source 16 to the DC bus capacitor 30 is reduced. Also, in another aspect, the polarization rectifier 40 also inhibits the electrolysis system 10 from operating in a reverse fuel-cell mode after power off by keeping the electrolysis system 10 voltage above the transition voltage when the electrolysis system 10 goes from fuel-cell mode to electrolysis mode, and typically within 10-20% above the transition voltage.

The electrolysis system 10 may be any conventional, presently known or future electrolysis system 10, such as those provided by Siemens Energy under the tradename Silyzer® or Elyzer®). The electrolysis system 10 typically includes one or more electrolysis cells 12 wherein the electrolysis activity occurs and reacted hydrogen is produced. For illustrative purposes in context of the illustrated embodiment, an electrolysis system 10 is shown operatively associated with a plurality of electrolysis cells 12 each of which cell 12 produces hydrogen. Although, as will be understood by those skilled in the art, not all of the cells 12 need to produce hydrogen for the electrolysis system 10 (e.g. if part of the cells in the stack or entire stacks are switched off or disconnected), and a single electrolysis cell 12 could be used in the electrolysis system 10 or the single electrolysis cell 12 could be used in a standalone mode to constitute the electrolysis system.

An electrolysis electrical circuit 14 is used in connection with the electrolysis system 10. The electrolysis electrical circuit 14 is operatively connected upstream of the electrolysis system 10, for example by being electrically connected to the electrolysis system 12 (as shown) or by being integrated directly into the electrolysis system 10 or in a combination thereof or in another suitable arrangement. The electrolysis electrical circuit 14 is used to (among other things) fully or partially power the electrolysis system 10. The illustrated electrolysis electrical circuit 14 is powered by a power source 16, e.g. public grid, via a transformer 18 that steps down the AC grid power voltage. However, as will be understood by those skilled in the art, the electrolysis electrical circuit 14 need not be powered by AC power. For example, the circuit 14 may be powered by DC power while utilizing an intermediate AC circuit.

Switchgear 19 may be optionally arranged downstream the power source 16 and configured to selectively electrically connect and disconnect the circuit 14 to the power source 16. However, there is no requirement that switchgear 19 be used, and power could be directed or selected to the circuit 14 in any of a variety of other suitable ways as will be understood by those skilled in the art. FIG. 2A exemplarily depicts a circuit 14 with switchgear 19 in an open position such that power from the grid 16 and high inrush current is prevented from arriving at the downstream IGBT rectifier 20, DC bus capacitor 30 and electrolysis system 10.

Referring still to FIGS. 2A and 2B, an insulated-gate bipolar transistor (IGBT) rectifier 20 is arranged downstream the power source 16 and switchgear 19. The IGBT rectifier 20 is configured to convert the AC power source 16 current to DC. The IGBT rectifier may be optionally further configured to maintain the overall power factor of the circuit 14 to near unity and to control low order harmonics of the circuit 14 to near zero, which are beneficial when connecting the electrolysis system 10 load to a public or islanded grid 16. Depending on the topology of the IGBT rectifier 20 (e.g. active front end rectifiers, Vienna rectifiers, IGCT-H bridges, or similar), the IGBT rectifier 20 may be unable to control or reduce the inrush current charging the DC link capacitor and/or electrolysis from the power source 16.

A filter 22 may be optionally arranged downstream the power source 16 and switchgear 19, and configured to filter or smooth the AC current, particularly if fast switching is utilized. However, there is no requirement that a filter 22 be used, and the AC current could be left as is, or be filtered or smoothed in any of a variety of other suitable ways as will be understood by those skilled in the art.

A DC bus capacitor 30 is arranged upstream of the IGBT rectifier 20 to reduce or eliminate high frequency ripples on the DC voltage. The DC bus capacitor 30 is used to control the voltage of the entire downstream DC bus.

In this configuration, when the IGBT rectifier 20 is activated, the DC bus capacitor 30 is charged in order to provide DC power to the electrolysis system 10, as the DC bus capacitor 30 is the dominating capacitance supplied by the IGBT rectifier 20. Additionally, electrolysis cells 12 feature a capacitive behavior, with total capacity depending on the number of cells 12 in series (decreasing capacity) and the active area (increasing capacity). Thus, when supplying the DC bus capacitor 30 with power from the grid 16, the inrush current must be limited for those IGBT rectifier 20 topologies that cannot control the current.

Still referring to FIGS. 2A and 2B, a polarization rectifier 40 is arranged upstream of the DC bus capacitor 30 and in parallel to the IGBT rectifier 20. The polarization rectifier 40 is used to prevent the electrolysis system 10 from operating in a reverse fuel-cell mode after power off by maintaining the electrolysis voltage close to the transition voltage when the electrolysis cells 12 switch from fuel-cell mode to electrolysis mode. In addition to this cut-off function, the polarization rectifier 40 can be activated before electrolysis system 10 startup in order to pre-charge the DC bus capacitor 30 prior to arrival of the startup inrush current from the power source. Recall that the DC bus capacitor 30 controls the voltage of the entire downstream DC bus and electrolysis system 10 as discussed above.

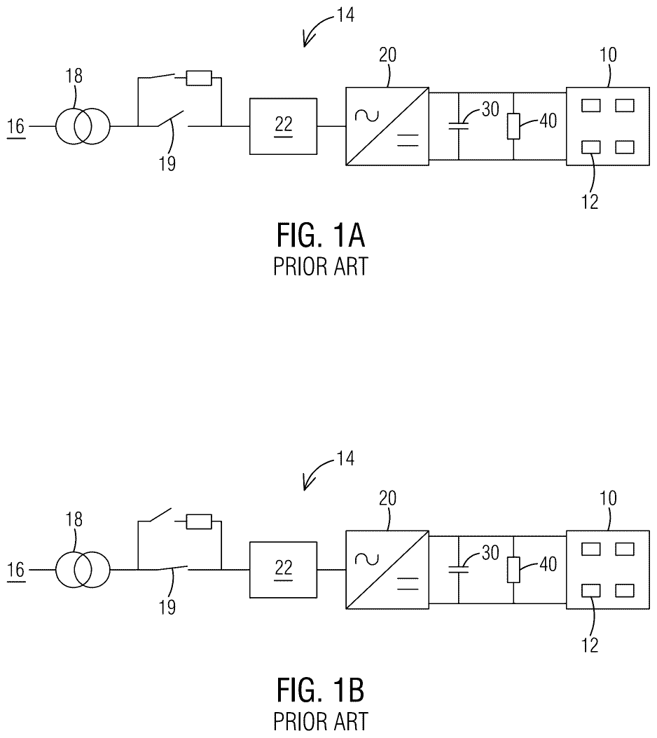

By pre-charging the DC bus capacitor 30 via the polarization rectifier 40 to a specific voltage, typically in the range of 1-2 volts per cell for PEM cells, and oftentimes in the range of 1.25-1.3 volts per cell for PEM cells, harmful inrush current to the DC bus capacitor 30 (as well as to the electrolysis system 10) can be reduced and even effectively eliminated. Similar voltages in the range of 1-2 volts per cell and slightly above the transition voltage between fuel-cell and electrolysis mode would apply for other electrolysis technologies. Also by this pre-charging configuration and operation, the optional switchgear 19 (including charging resistor arranged upstream and in parallel to the bypass switch, see FIGS. 1A and 1B) can be rendered unnecessary and thus removed from the electrolysis circuit 14, thereby reducing circuit 14 cost and increasing simplicity and efficiency.

Control logic 50 software or firmware may be utilized with the electrolysis circuit 14 or system 10 in order to control, automate or optimize the pre-charging of the DC bus capacitor 30. In one exemplarily manner, the control logic 50 is associated with an electrolysis system 10 startup mode. The charging time of the DC bus capacitor 30 is determined based on the ratings of the capacitor 30 and the polarization rectifier 40 and considered in the timing of the start-up procedure. When the start-up signal is sent, the charging of the DC bus capacitor 30 and electrolysis by the polarization rectifier 40 is initiated, once all systems are ready. A set-point is determined and compared to the DC voltage measurement values. Once a threshold voltage or a steady-state voltage is met, a ready signal is sent, which enables operation of the main switch connecting the electrolysis power supply to the power source 16. When switching-on the main power source, the voltage at the DC bus increases to the minimum electrolysis operation voltage or higher. The polarization rectifier 40 may remain in operation or be switched-off afterwards.

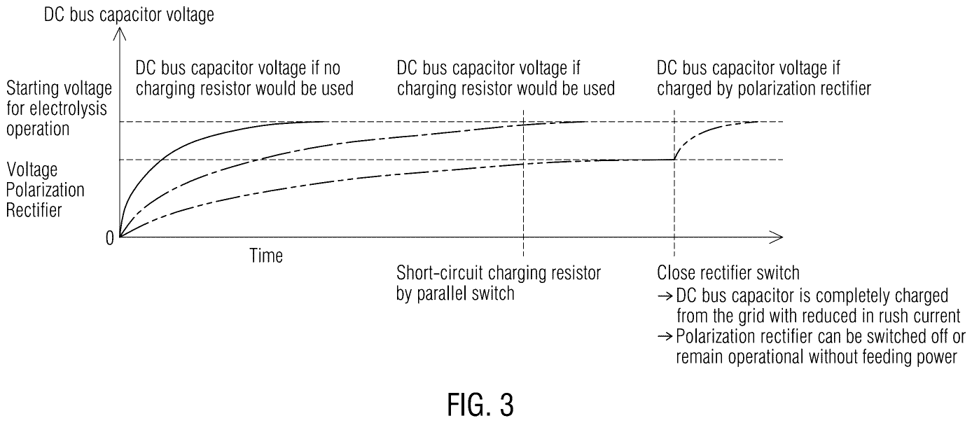

Referring now to FIG. 3, a voltage versus time diagram showing the electrolysis system 10 startup is provided. Three general scenarios are shown. In a first scenario (solid line without dashes), no charging resistor and no polarization rectifier are used. The DC bus voltage increases fastest to reach starting voltage of electrolysis operation, thus drawing the highest inrush current. In a second scenario (line with single dashes), a charging resistor is used to charge the DC bus in a medium period. In a third scenario (line with double dashes), the polarization rectifier 40 is used to charge the DC bus to the nominal voltage of this rectifier. The required period is expected to be the longest in the three scenarios, depending on the power rating of the polarization rectifier 40. After this voltage is reached, the connection to the main power source is closed. The voltage increases quickly to the minimum electrolysis operation voltage. The resulting inrush current is significantly reduced, since the difference between the minimum IGBT output voltage and the DC bus capacitor voltage is reduced compared to scenario one.

While the above-described electrical circuit 14 has been illustrated in an exemplary context of use to mitigate high inrush current for electrolysis systems 10, as will be understood by those skilled in the art, the electrical circuit 14 can be used in many other contexts of use to mitigate high inrush current other than with electrolysis systems 10, if an additional charging source is applied. Some exemplary potential applications include rectifiers for drive applications, battery applications or DC-DC converters, basic voltage source converters, as will be understood by those skilled in the art.

While specific exemplary embodiments and illustrations have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the subject matter, which is to be given the full breadth of the appended claims, and any and all equivalents thereof.

What is claimed is:

1. An electrolysis electrical circuit 14 operatively connected to an electrolysis system 10, comprising:
an IGBT rectifier 20 arranged downstream of an AC power source 16, the IGBT rectifier 20 configured to convert the AC power source 16 current to DC;
a DC bus capacitor 30 arranged downstream of the IGBT rectifier 20, the DC bus capacitor 30 configured to control the voltage of the downstream DC bus and to enable powering of the electrolysis system 10; and
a polarization rectifier 40 arranged downstream of the DC bus capacitor 30 and in parallel to the IGBT rectifier 20, the polarization rectifier 40 configured to pre-charge the DC bus capacitor 30 prior to startup of the electrolysis system 10,
whereby an inrush current from the AC power source 16 to the DC bus capacitor 30 is reduced.

2. The electrolysis electrical circuit 14 of claim 1, wherein the electrolysis system 10 comprises a plurality of electrolysis cells 12.

3. The electrolysis electrical circuit 14 of claim 1, wherein the AC power source 16 comprises a public, industrial, or islanded power grid operatively connected to a transformer 18.

4. The electrolysis electrical circuit 14 of claim 1, wherein a switchgear 19 is arranged downstream of the power source 16, the switchgear 19 configured to selectively electrically connect and disconnect the circuit 14 to the power source 16 such that the AC current is prevented from arriving at the upstream IGBT rectifier 20, DC bus capacitor 30 or electrolysis system 10.

5. The electrolysis electrical circuit 14 of claim 1, wherein a filter 22 is arranged downstream the power source 16 and the switchgear 19, and configured to filter or smooth the AC current.

6. The electrolysis electrical circuit 14 of claim 1, wherein the IGBT rectifier 20 is further configured to maintain the overall power factor of the circuit 14 to near unity and to control low order harmonics of the circuit 14 to near zero.

7. The electrolysis electrical circuit 14 of claim 1, wherein the IBGT rectifier comprises a converter system featuring a DC bus capacitor.

8. The electrolysis electrical circuit 14 of claim 1, wherein the DC bus capacitor 30 is further configured to smooth high frequency ripples on the DC voltage.

9. The electrolysis electrical circuit 14 of claim 1, wherein the polarization rectifier 40 is configured to pre-charge 30 the DC bus capacitor 30 to within the range of 1-2 volts per cell.

10. The electrolysis electrical circuit 14 of claim 1, wherein the polarization rectifier 40 is configured to pre-charge 30 the DC bus capacitor 30 to within the range of 1.25-1.3 volts per cell.

11. The electrolysis electrical circuit 14 of claim 1, wherein the operation of a pre-charged DC bus capacitor 30 reduces the inrush current from the AC power source 16 to the electrolysis system 10.

12. The electrolysis electrical circuit 14 of claim 1, wherein the polarization rectifier 40 also inhibits the electrolysis system 10 from operating in a reverse fuel-cell mode after power off by keeping the electrolysis system 10 above the transition voltage when the electrolysis system 10 goes from fuel-cell mode to electrolysis mode.

13. The electrolysis electrical circuit 14 of claim 1, further comprising start control logic to control, automate or optimize the pre-charging of the DC bus capacitor 30.

14. An electrolysis system 10 startup mode, comprising:
pre-charging a DC bus capacitor 30 prior to startup of the electrolysis system 10 via a polarization rectifier 40 arranged downstream of the DC bus capacitor 30;
receiving AC power from an AC power source 16 in order to startup the electrolysis system 10;
reducing a startup inrush current from the AC power source 16 to the DC bus capacitor 30 by pre-charging the DC bus capacitor 30;
converting the AC power to DC power via an IGBT rectifier 20 arranged downstream of the AC power source 16 and configured to accommodate fast switching; and
enabling powering of the electrolysis system 10 via the DC bus capacitor 30.

15. The electrolysis system 10 startup mode of claim 14, further comprising controlling the pre-charging of the DC bus capacitor 30 via a start control logic software or firmware 50.

16. The electrolysis system 10 startup mode of claim 15, wherein the start control logic software or firmware 50 is configured to pre-charge the DC bus capacitor 30 within the range of 1-2 volts per cell.

17. The electrolysis system 10 startup mode of claim 14, further comprising fully or partially controlling the DC bus voltage downstream the IGBT rectifier 20 via the DC bus capacitor 30.

18. The electrolysis system 10 startup mode of claim 14, wherein the polarization rectifier 40 also inhibits the electrolysis system 10 from operating in a reverse fuel-cell mode after power off by keeping the electrolysis system 10 above but within 15% of the transition voltage when the electrolysis system 10 goes from fuel-cell mode to electrolysis mode.
